(19) United States
(12) Patent Application Publication
(10) Pub. No.: US 2008/0115878 A1
(43) Pub. Date: May 22, 2008

(54) Continuous lamination of door panels

(76) Inventors: Willis J. Mullet, Gulf Breeze, FL (US); Richard H. Swasey, Pace, FL (US); Dewayne J. Davidson, Pace, FL (US); Donald M. Roman, North Lawrence, OH (US); William S. Wilson, Pace, FL (US); Craig T. McFarren, Pace, FL (US); George D. Knupp, Pensacola, FL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/600,378

(22) Filed: Nov. 16, 2006

(51) Int. Cl. B32B 37/12; B32B 37/30; B29C 47/00; B32B 38/00; B29C 47/08

(52) U.S. Cl. 156/146; 156/292; 156/244.22; 156/196; 156/244.18

(57) ABSTRACT

A method of forming a door panel is accomplished by providing a plurality of spaced rollers. A first plastic facer is drawn beneath the rollers wherein the first facer is in the form of a continuous sheet having an upwardly facing surface. A second plastic facer is drawn beneath the rollers, and is in the form of a continuous sheet and at least a portion of the second facer is spaced above the first spacer. A pair of rails are positioned on opposed sides of the first facer and drawn beneath the rollers. A foam material is deposited on the upwardly facing surface prior to drawing the first facer beneath the rollers. The foam material expands and hardens to adhere together the first facer, second facer and rails into a continuous length of assembled panel.

### TECHNICAL FIELD

One or more embodiments of the present invention relate to methods of continuously producing panels. Specifically, one or more embodiments of the present invention relate to methods of continuously producing garage door panels.

### BACKGROUND ART

Movable barriers, such as garage doors and the like, generally include a multi-panel door supported by a track system, upon which the door is movable between an open, horizontal position and a closed, vertical position. The door panels are pivotally secured to each other via hinges and movably secured to the track system via rollers.

Consumers have steadily indicated a desire for lighter weight, thermally efficient door panels, to reduce energy costs and noise while improving safety. Such door panels may be constructed using a front facer and a rear facer that define a volume therebetween. That volume may be filled with a foamed polymer material or the like. The foam adds structural integrity, adheres the panel components together, and improves the door's insulating properties. Such designs are lighter and in some cases cheaper than traditional solid wood or metal doors.

In some cases these foam filled panels have been constructed using both a non-metal front facer and a non-metal rear facer. Such panels typically include internal metal supports, also referred to as rails, to provide added stability. Further, such door panels were made in a batch process wherein the front facer was placed in a cavity, the rails were positioned and held in place, a foaming polymer was provided, and finally a rear facer was positioned over the front facer and rails. The assembly was then held under pressure in the cavity for a predetermined period of time until the foaming polymer expanded and filled the volume between the two facers and rails. After such time the completed door panel is removed and the process is repeated.

Though the aforementioned method was successful in making door panels having non-metal front and rear facers, certain limitations were evident. Most notably, the batch process is not conducive to high production rates. Thus, door panels made by this process are inherently more expensive to make than panels made in a continuous fashion.

Thus, there exists a need in the art for a method of continuously forming door panels having non-metal front and rear facers.

### SUMMARY OF THE INVENTION

In light of the foregoing, it is a first aspect of the present invention to provide a continuous lamination of door panels.

It is another aspect of the present invention to provide a method of forming a door panel comprising, continuously providing a first facer having opposed longitudinal edge profiles, continuously securing a metal rail to each opposed longitudinal edge profile, continuously bringing a second facer into contact with the rails, and drawing the first facer, the second facer and the rails through a laminator including a plurality of rollers, wherein the rollers releasably position the rails as they are drawn through the laminator.

It is still another aspect of the present invention to provide a method of forming a door panel comprising, providing a first non-metallic facer having opposed longitudinal edge profiles joining the first non-metallic facer with a pair of metallic rails and a second non-metallic facer, the rails being positioned proximate the longitudinal edge profiles, providing a foaming material, the foam being expandable to fill substantially the entire volume defined between the first non-metallic facer, the second non-metallic facer and the rails, drawing the first facer, the second facer, the foaming material and the rails through a laminator, including a plurality of rollers, wherein the rollers include guides that releasably position the rails as they are drawn through the laminator.

It is yet another aspect of the present invention to provide a method of forming a door panel comprising, providing a plurality of spaced rollers above a moving surface, drawing a first plastic facer between the rollers and the moving surface, the first facer being in the form of a continuous sheet and having an upwardly facing surface, drawing a second plastic facer between the rollers and the moving surface, the second facer being in the form of a continuous sheet and at least a portion of the second facer being positioned above the first facer, positioning a pair of rails on opposed sides of the first facer and drawing the rails between the rollers and the moving surface, depositing a foam material on the upwardly facing surface prior to the step of drawing the first facer between the rollers and the moving surface, wherein the foam expands and hardens to adhere together the first facer, second facer and rails into a continuous length of the door panel.

It is still another aspect of the present invention to provide a method of forming a door panel comprising, providing a first non-metallic facer having opposed longitudinal edge profiles, joining the first non-metallic facer with a pair of metallic rails and a second non-metallic facer, the rails being positioned at the longitudinal edges of the first non-metallic facer, providing a foaming material, the foam being expandable to fill substantially the entire space between the first non-metallic and the second non-metallic facer, continuously drawing the first non-metallic facer, the second non-metallic facer, the foaming material and the metallic rails through a laminator including at least one guide, to position the rails while moving therethrough.

### BRIEF DESCRIPTION OF THE DRAWINGS

For a complete understanding of the objects, techniques and structure of the invention, reference should be made to the following detailed description and accompanying drawings, wherein:

FIG. 1 is a side elevation view of a facer production station according to the present invention;

FIG. 2 is a top plan view of the facer production station;

FIG. 3 is a top plan view of an extruder and embossing roller;

FIG. 4 is a top view of a vacuum former which are part of the facer production station according to the present invention;

FIG. 5 is a side cross-sectional view of the vacuum former taken along lines 5-5 of FIG. 4;

FIG. 6 is a front view of first edge formers employed by the facer production station;

FIG. 7 is a front view of second edge formers employed by the facer production station;

FIG. 8 is a front view of a facer sheet immediately after extrusion;

FIG. 9 is a front view of the facer sheet after passage through the vacuum former;

FIG. 10 is a front view of the facer sheet after passage through the first edge formers;

FIG. 11 is a front view of the facer sheet after passage through the second edge formers;

FIG. 12 is an isometric view of the completed front facer;

FIG. 13 is an isometric view of a rail forming area of the present invention;

FIG. 14 is a side plan view of the rail forming area and a laminating area;

FIG. 15 is an end view of a left rail of the present invention after exiting a left rail former;

FIG. 16 is a an end view of a right rail of the present invention after exiting a right rail former;

FIG. 17A is a close-up isometric view of a first guide block;

FIG. 17B is a section view of the first guide block along lines 17B-17B of FIG. 17A;

FIG. 18A is a close-up isometric view of a second guide block;

FIG. 18B is a section view of the second guide block along lines 18B-18B of FIG. 18A;

FIG. 19A is a close-up isometric view of a third guide block;

FIG. 19B is a section view of the third guide block along lines 19B-19B of FIG. 19A;

FIG. 20A is a close-up isometric view of the fourth guide block;

FIG. 20B is a section view of the fourth guide block along lines 20B-20B of FIG. 20A;

FIG. 21A is a close-up isometric view of a fifth guide block;

FIG. 21B is a section view of the fifth guide block along lines 21B-21B of FIG. 21A;

FIG. 22 is a close-up isometric view of a pressing assembly according to the present invention;

FIG. 23 is a section view of a left side sub-assembly of the pressing assembly along lines 23-23 of FIG. 22;

FIG. 24 is a partial assembly isometric view of the right side sub-assembly of the present invention;

FIG. 25 is a section view of a right side sub-assembly of the pressing assembly along lines 25-25 of FIG. 24;

FIG. 26 is an isometric view of a laminator according to the present invention;

FIG. 27A is a section view of a laminator roller according to the present invention in a first position;

FIG. 27B is a section view of the laminator roller shown in a second position;

FIG. 27C is a section view of the laminator roller of shown in a third position;

FIG. 28A is a section view of the alternate laminator roller according to the present invention in a first orientation;

FIG. 28B is a section view of the alternate laminator roller according to the present invention in a second orientation;

FIG. 28C is a section view of the alternate laminator roller according to the present invention in a third orientation;

FIG. 28D is a section view of the alternate laminator roller according to the present invention in a fourth orientation;

FIG. 29 is a cross-section view of a cured door panel made according to the present invention;

FIG. 30 is a detailed cross-section view of edge profiles of the cured door panel;

FIG. 31 is an elevated plan view of a cutting and post assembly area and according to the present invention;

FIG. 32 is an isometric view of a cured door panel including mounted hardware.

### BEST MODE FOR CARRYING OUT THE INVENTION

Door panels manufactured according to the present invention are typically provided as part of a garage door system, wherein a plurality of adjoining panels are pivotally secured to one another to form a door assembly. The door assembly rides along a track system and is movable between a generally vertical, closed, orientation, and a generally horizontal open, orientation. It should be appreciated, however, that the foregoing method may be employed to manufacture any type of construction or door panels.

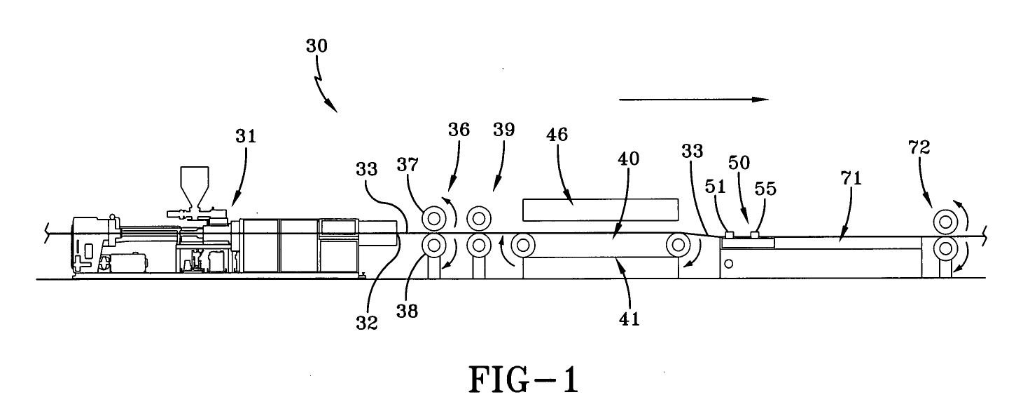

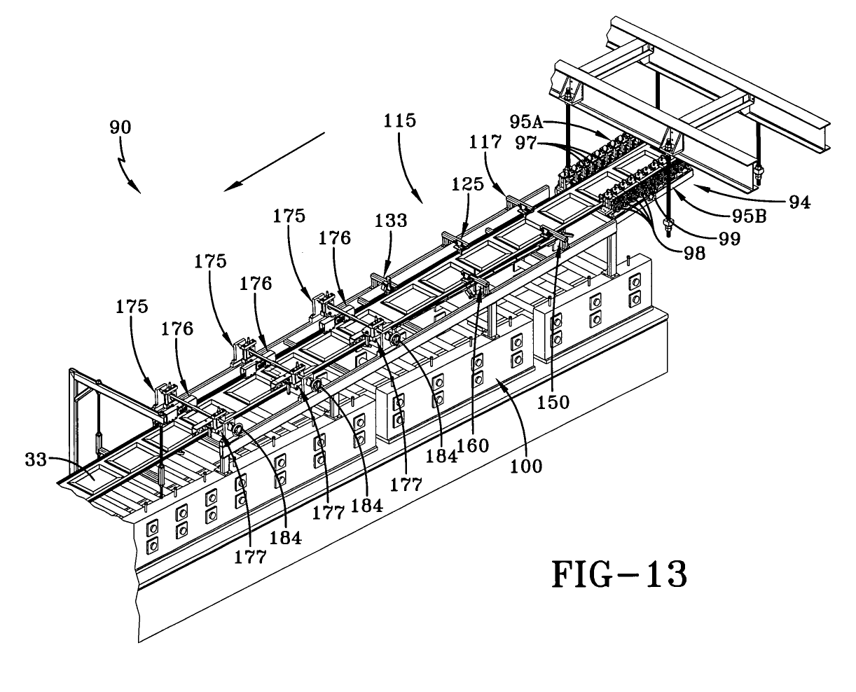

The manufacturing process of the present invention may be described generally as having three distinct steps or stations. In a facer forming area, shown in FIG. 1, a front facer is formed in a continuous fashion by extruding a sheet of plastic and shaping that sheet into a final form. This front facer is then directed to a rail forming and insertion area, shown in FIG. 13, where metal rails are continually formed and joined with the front facer. Finally, in a laminating area, shown in FIG. 26, a foaming material is discharged onto the rail and front facer assembly. Thereafter, a back facer is continuously provided to complete the exterior shell of the panel. The assembly is thereafter directed through a laminator to maintain the position of the components while allowing the foam to expand and fill the interior volume. After exiting the laminator, the foam is substantially cured and the panel may be cut to length. In one embodiment, if the panels are used in conjunction with a garage door system, the panels may be provided with appropriate hardware, and assembled with other panels to form the garage door.

Referring now to the drawings, an exemplary door panel manufacturing method will now be described. FIGS. 1 and 2 show a facer forming area generally designated by the numeral 30. Facer forming area 30 includes an extruder 31 that produces a continuous sheet of pliable plastic material at a constant rate of speed. As is known in the art, extruder 31 is supplied with plastic stock material, typically in the form of pellets, which are heated and pressed through an extruder die 32. In the present embodiment, the plastic stock material is a thermoplastic material such as polyvinylchloride, although any plastic material (including for example, thermoset plastics) may be used so long as it is appropriate for use in an extruder and exhibits sufficient strength and weathering properties. The extruder die 32 of the present embodiment may be described as an elongated straight slot, so that when plastic material is forced therethrough, a continuous flattened front facer 33 in the form of a sheet is produced. Indeed, sheet 33 may also be referred to herein as front facer sheet 33 or front facer 33.

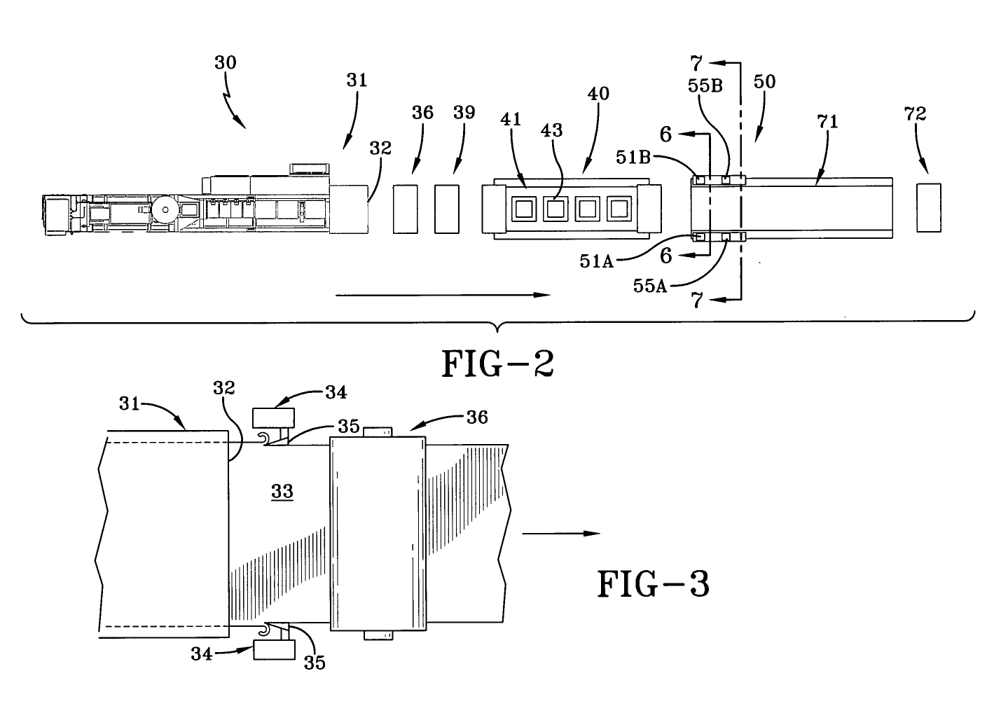

Referring to FIG. 3, extruder 31 may include a width control mechanism 34, that is capable of selectively varying the width of front facer sheet 33 to allow for various door panel designs and sizes. As is known in the art, changing the extruder die is somewhat difficult and time consuming, thus, the width control mechanism 34 enables relatively easy width adjustments. In one or more embodiments, width control mechanism 34 may be in the form of a pair of adjustable blades 35 positioned on opposed lateral sides of extruder die 32. The blades may be moved inwardly or outwardly depending on the desired sheet width and front facer material that contacts the blades is sheared, to be disposed of or recycled. In this manner, front facer sheets of varying widths may be formed using the same extruder die.

After exiting extruder die 32, the thermoplastic material of the front facer sheet 33 has not yet taken a permanent shape, is still impressionable, and may be directed through an embossing roller assembly 36. Embossing roller assembly 36 may include at least one upper roller 37 and an opposed, spaced apart lower roller 38. Rollers 37 and/or 38 may be provided with a textured circumferential surface, and when passed therebetween, that texture may be transposed onto the surface or surfaces of the impressionable sheet 33. Such textures may be for decorative purposes or may be provided to promote adherence to other door panel components, as will herein after be discussed. Embossing roller assembly 36 is further provided to propel front facer sheet 33 toward a vacuum former 40 at a predetermined or regulated speed.

Optionally, a temperature compensator 39 may be provided downstream of the embossing roller 36 and prior to vacuum former 40. Temperature compensator 39 may be employed to regulate or adjust the temperature of front facer sheet 33 prior to entry into vacuum former 40. For example, temperature compensator 39 may be in the form of a pair of opposed, spaced apart rollers. If cooling is desired, the rollers may be cooled, for example by a continuous internal stream of chilled fluids. Conversely, if it is desired to maintain a high front facer sheet temperature, the rollers may be heated, by for example, a continuous internal stream of hot fluids. In this manner, the temperature of front facer sheet 33 may be regulated to achieve optimal shaping and forming properties.

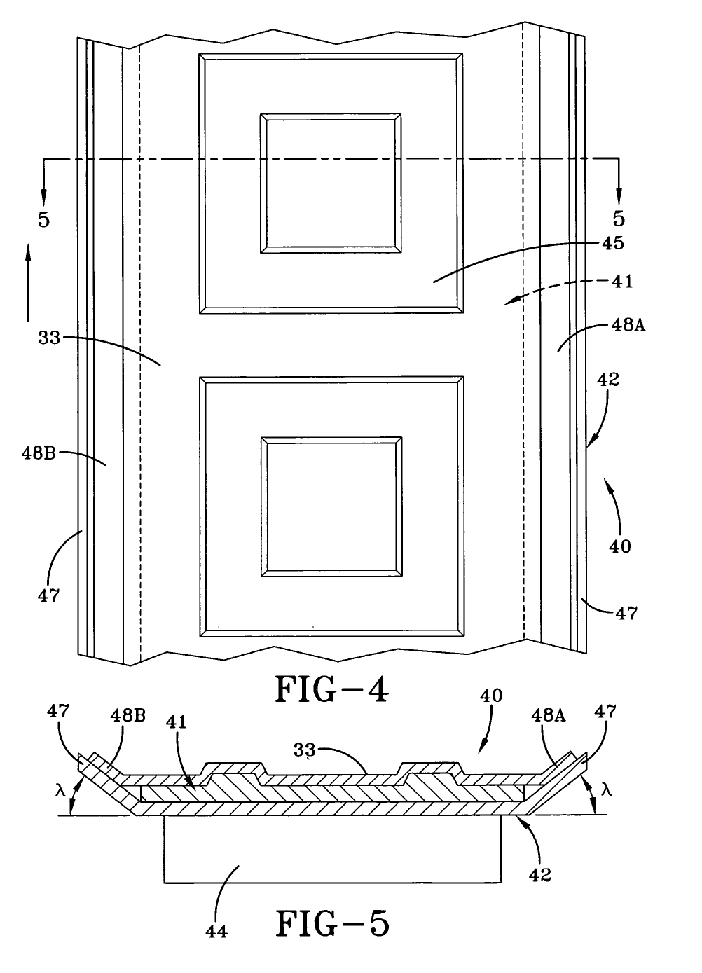

Front facer sheet 33 is drawn through vacuum former 40 shown in FIGS. 2, 4 and 5 to form a variety of raised patterns thereon. As will become evident, when assembled in a door system, front facer 33 of the completed door panel is positioned on the exterior side of the door and thus, decorative patterns or embossments may be desirable. Vacuum former 40 may therefore include a patterned loop or belt 41 that is continually drawn along the top surface of a stationary table 42. Belt 41 may be made of flexible material such as rubber or plastic and may include a raised repeating pattern 43 on the outer surface thereof. Both belt 41 and table 42 include a plurality of holes therethrough (not shown). A vacuum is drawn from beneath table 42 by a suction device 44. Through the plurality of holes, the vacuum draws front facer sheet 33 firmly against belt 41 as seen in FIG. 5. Because front facer sheet 33 is still hot, and thus relatively malleable, the raised pattern 43 of belt 41 is transferred onto front facer sheet 33 forming a patterned surface area 45. Further, because belt 41 is continuously circulated around stationary table 42, front facer sheet 33 is effectively pulled through the vacuum former 40.

Vacuum former 40, as seen in FIG. 1, may further include a cooling system 46 that cools front facer sheet 33 as it travels through vacuum former 40. Cooling system 46 may be positioned above belt 41 and distributes a cooling liquid on front facer sheet 33 as it travels therethrough. The cooling liquid may be water which may be sprayed from a plurality of jets so that the water is dispersed in small droplets to maximize thermal transfer. A trough (not shown) may be provided underneath the belt 41 to collect excess liquid for disposal or re-circulation to the cooling system.

Stationary table 42, as seen in FIG. 5, may also include opposed ledges 47 that are disposed at angle λ relative to belt 41. In one or more embodiments, angle λ may be from about 30 to about 60 degrees relative to belt 41. In other embodiments, angle λ may be about 45 degrees, relative to belt 41. As shown in FIG. 5, opposed edge portions 48 of front facer sheet 33 extend beyond belt 41 and overlie ledges 47 as sheet 33 is drawn there through. Thus, as front facer sheet 33 is pulled through vacuum former 40, edge portions 48 are bent upwardly by ledges 47. As will become evident, the forming of the angled edge portions helps in the formation of edge profiles that are created to promote interfacing with other door panel components. Also, it should be appreciated that other vacuum former designs and configurations may be employed. Other exemplary vacuum formers are disclosed in U.S. Pat. Nos. 6,641,384 and 5,906,840 which are hereby incorporated by reference.

Front facer sheet 33 exits vacuum former 40 with the raised patterned surface area 45. Further, front facer sheet 33 is cooler than when it entered vacuum former 40. It is, however, not completely set and is therefore still malleable. Thus, in particular, edge portions 48 of sheet 33 may still be bent or otherwise formed, as will be hereinafter described. To complete the formation of edge portions 48, front facer sheet 33 is next drawn through a post forming area 50 which is best seen in FIGS. 1 and 2. Post forming area 50 may include formers which provide a plurality of spaced apertures or slots, through which edge portions 48 are directed through. Each aperture may include a shape that is sequentially more similar to the final desired end profile. Further, as will become apparent, the profile of left edge portion 48A may be different than the profile of right edge portion 48B.

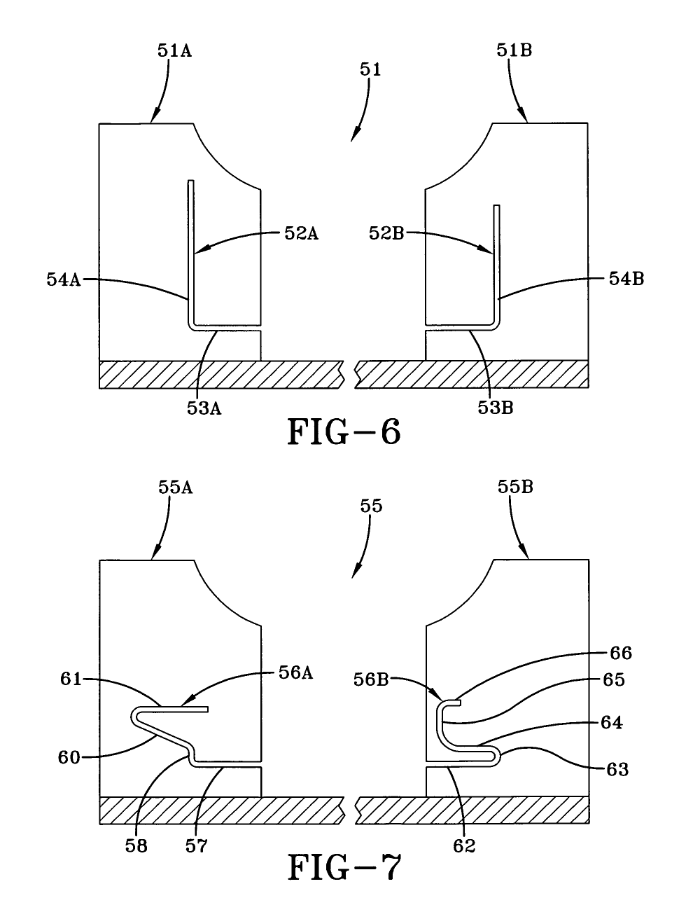

Referring to FIG. 2 and primarily to FIG. 6, a former, which is designated generally by the numeral 51, comprises exemplary first edge formers 51A and 51B. Edge formers 51A and 51B are laterally spaced apart to allow the passage of a significant portion of front facer sheet 33 therebetween. Each edge former 51A and 51B has a corresponding slot 52A and 52B, both of which have a substantially lateral slot portion 53A and 53B, that is contiguous with a substantially perpendicular slot portion 54A and 54B. Edge former 51A receives the left edge portion 48A and edge former 51B receives the right edge portion 48B. As edge portions 48 are drawn through the respective slots 52, they are bent to a substantially 90 degree angle relative to the patterned surface 45 of front facer sheet 33. In other words, edge formers 51A and 51B transition the edge portions 48 from an acute angle orientation to a substantially right angle orientation which is receptive to further forming and/or manipulation. The result of this forming operation can be seen in FIG. 10.

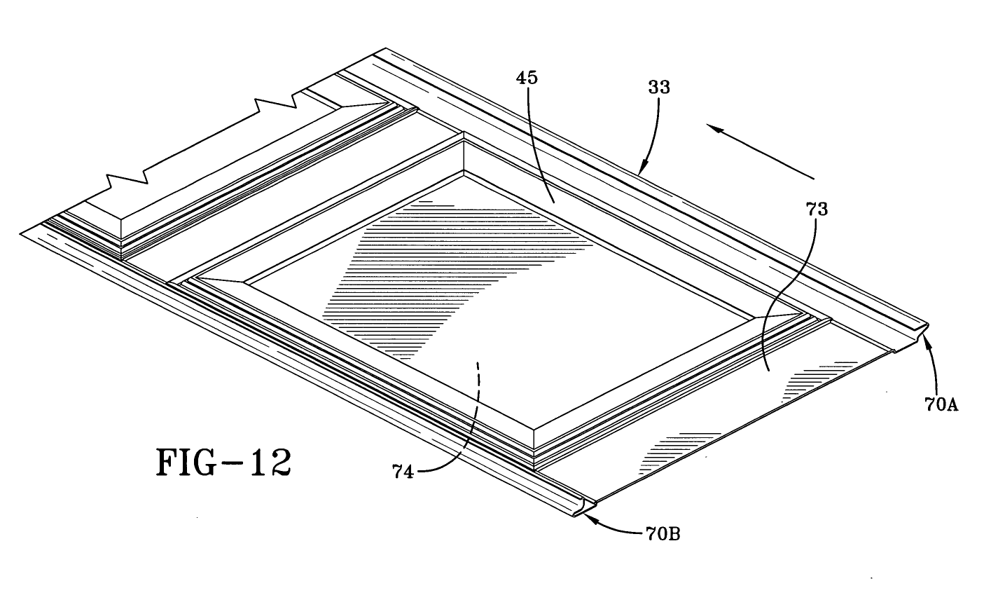

Referring now to FIG. 7, a former, which is designated generally by the numeral 55, comprises a second pair of edge formers 55A and 55B. As seen in FIGS. 1 and 2, the former 55 is positioned downstream of the former 51. The edge formers 55A and 55B are also spaced apart from one another to allow the passage of the facer sheet 33 therebetween. Second edge former 55A receives the left edge portion 48A and second edge former 55B receives right edge portion 48B through their respective slots 56A and 56B. As edge portions 48 are drawn therethrough, they are shaped into the respective profiles of slots 56. In particular, the slot 56A of edge former 55A has a substantially lateral slot portion 57 that is contiguous with a substantially perpendicular slot portion 58 which is contiguous with an outwardly angular slot portion 60 that is contiguous with and terminates at an inwardly lateral slot portion 61. In a somewhat similar manner, edge former 55B provides a slot 56B which has a substantially lateral slot portion 62 that is continuous with a u-shaped lateral slot portion 63. The slot 56B further extends with an inward slot portion 64 that is continuous with an upwardly curved slot portion 65 which is contiguous with and terminates at an outward slot portion 66. After passage therethrough, edge portions 48 retain the shape of finished edge profiles 70A and 70B (seen in FIG. 11) and the cooling of front facer sheet 33 may be completed to set the formed shapes. It should be appreciated that more or less edge formers may be employed to shape the edge portions 48. For example, more formers may be used in sequence to more gradually form edge portion 48 and reduce the likelihood of binding or damaging stresses. Further, edge profile shapes may be used that differ from those shown in FIGS. 6 and 7.

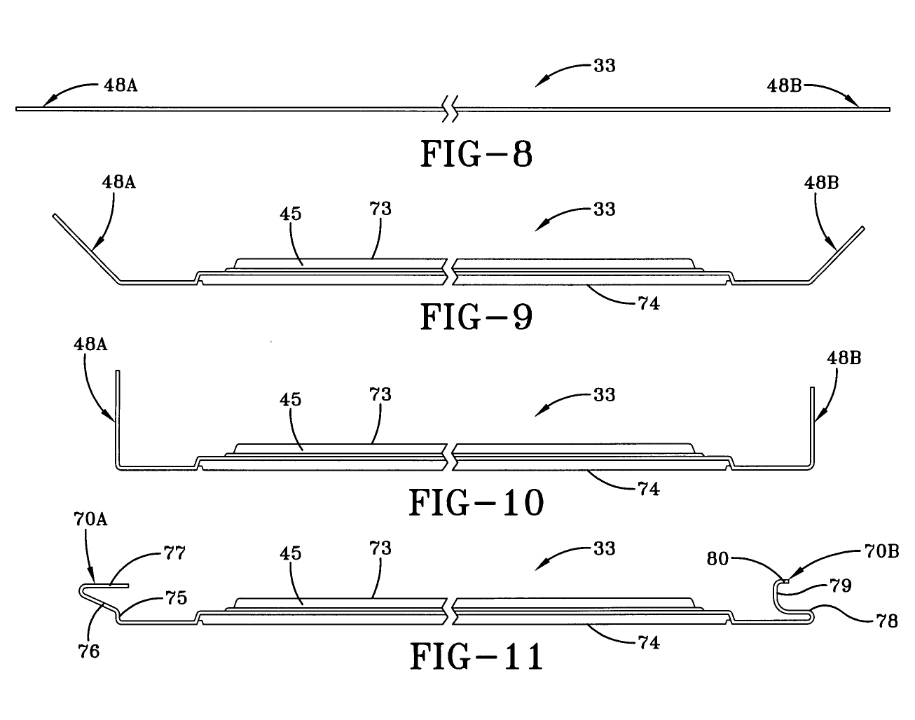

Referring now to FIGS. 8-11, a sequential progression of the forming of front facer 33, and particularly edge portions 48, can be seen. FIG. 8 displays facer sheet 33 as it exits extruder 31. As is evident, the facer sheet 33 exhibits a generally flattened cross-sectional shape that may be later embossed by roller assembly 36. After exiting vacuum former 40, facer sheet 33, as seen in FIG. 9, includes patterned surface 45 formed by patterned belt 41. Further, edge portions 48, which are formed by ledges 47, are disposed at about a 45 degree angle relative to patterned surface 45 of facer sheet 33. After passing through first formers 51, edge portions 48 may now be bent at a 90 degree angle, as shown in FIG. 10. Finally, after passing through second former 55, the edge portions 48A and 48B are converted into final end profiles 70A and 70B as shown in FIG. 11. Thus, in this manner, a continuous front facer 33 is formed having a patterned surface 45 and end profiles 70.

Facer sheet 33 is next drawn through a water bath 71, shown in FIGS. 1 and 2, to complete the cooling process and permanently set the shape thereof. Upon exiting water bath 71, facer sheet 33 is no longer impressionable and will thereafter maintain its pattern and end profiles. A puller assembly 72 may be provided to draw facer sheet 33 out of water bath 71. Puller assembly 72 may be in the form of a pair of motorized opposed rollers wherein the opposed rollers counter-rotate to draw front facer sheet 33 through at a predetermined speed.

As shown in FIGS. 11 and 12, a continuous front facer sheet 33 exits facer forming area 30. Front facer 33 includes a top or inner surface 73 and an opposed bottom or outside surface 74. Further, opposed edge profiles 70 are shaped in a manner that assists the assembly with other panel components. Finally, in the present embodiment, patterned area 45 is provided in the form repeating raised squares, though it should be appreciated that any pattern may be chosen depending upon user requirements or desires. Further, if desired, a pattern-less surface may be provided which may be particularly suitable for industrial applications and the like.

In the present embodiment left and right edge profiles have different shapes. Left profile 70A includes a first leg 75 extending upwardly from sheet 33, a second leg 76 extending at an upward angle from first leg away from patterned area 45, and a third substantially horizontal leg 77 extending inwardly from second leg 76 toward patterned area 45. Right profile 70B includes a first hook shaped leg 78 extending from sheet 33 inwardly toward patterned surface 45, a second leg 79 curving and extending upwardly from first leg 78, and a third generally horizontal leg 80 extending from leg 79 away from patterned surface 45. It should be appreciated that the above referenced profiles 70 are exemplary, and other profiles may be employed within the scope of the present invention.

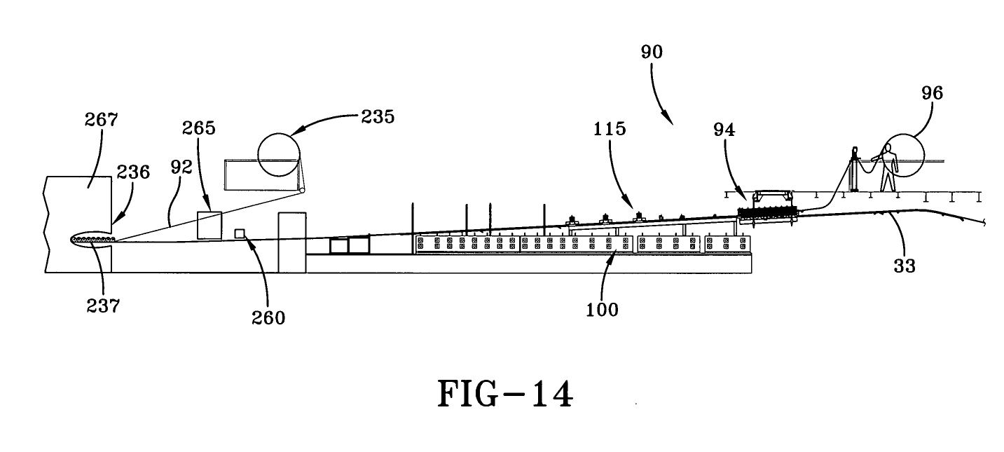

The completed front facer 33 may now be guided to a rail forming and insertion area 90 (hereinafter rail area 90), shown in FIGS. 13-14. It should be appreciated that prior to entry into rail area 90, a portion of front facer 33 may be allowed to accumulate or hang slack. This accumulation area may be employed to reduce residual tension on front facer 33 and/or allow for minor variations or fluctuations in production speeds between the facer forming area 30 and the rail area 90.

In rail area 90, a pair of rails 91A and 91B are formed and joined with front facer 33. Front facer 33 is first drawn through a rail forming apparatus 94 which is adapted to continuously shape metal strips into a desired cross-sectional profile. Rail forming apparatus 94 includes a left side rail former 95A and a right side rail former 95B. Rail formers 95A and 95B are spaced apart to allow front facer 33 to travel uninhibited therebetween. Each rail former 95 is continuously fed from a separate rail stock roll 96. The rail stock is of metal composition and is initially in the form of a flattened strip, wound into roll 96. The metal stock is fed through respective rail formers 95 which shape the metal stock as it travels therethrough. Rail formers output shaped rails 91 at a speed substantially matching the speed front facer 33 as it travels through rail area 90. In the present embodiment each rail former 95 may include a plurality of rotating wheels 97 positioned sequentially to shape the passing metal stock. Each rail former may be driven through a gear arrangement 98 driven by a motor 99.

Rail forming apparatus 94 is positioned above a metal facer forming apparatus 100. As is known in the art, some prior art door panels are formed with a metal front facer as opposed to the plastic front facer and metal rail combination of the present invention. Though apparatus 100 is not used during the presently disclosed process, when it is desired to manufacture metal faced panels, appropriate metal stock may be fed through metal facer forming apparatus 100 to form the appropriate edge profiles and other features of the metal facer. Thus, the laminator discussed later in this disclosure may be used conveniently to produce either metal or plastic faced door panels with relatively quick changeover time.

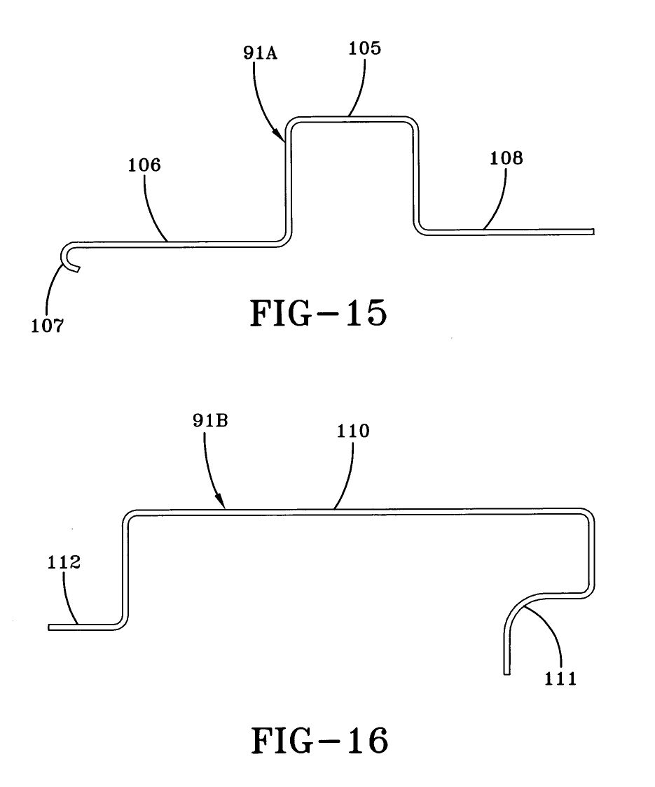

After shaping by rail forming apparatus 94, rails 91 are ready to be joined with front facer 33. Rails 91 provide structural stability, as well as a sturdy mounting area for brackets, hinges or other hardware. Referring now to FIG. 15, it can be seen that, left rail 91A includes a central inverted U-shaped leg 105. A second generally flat leg 106 extends laterally outward from U-shaped leg 105 and terminates at a hook portion 107. A third, generally flat leg 108 extends laterally inward from the opposed side of U-shaped leg 105.

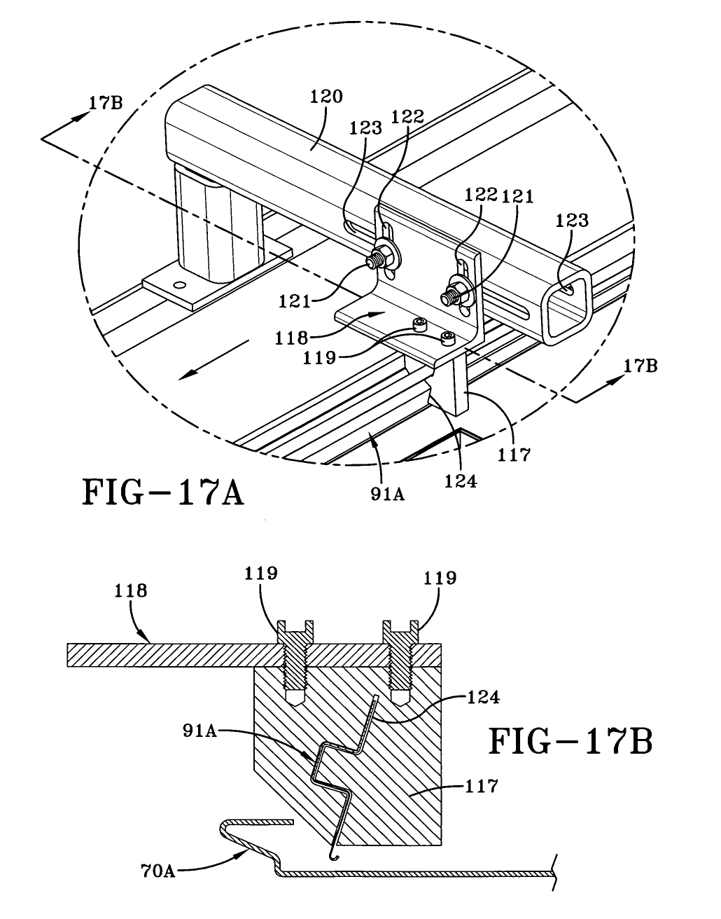

Referring now to FIG. 16, right rail 91B includes a central, U-shaped leg 110. An L-shaped leg 111 extends inwardly and downward from the lateral outer edge of U-shaped leg 110. Finally, a third, generally flat leg 112 extends laterally outward from the opposed end of U-shaped leg 110.

Downstream of rail forming apparatus 94, rails 91 and front facer 33 are joined by a merging apparatus designated generally by the numeral 115. Merging apparatus 115 generally includes a plurality of guides and rollers that allow rails 91 to be continuously joined with front facer 33. Referring to FIGS. 17A and 17B, after exiting rail former 95A, left rail 91A is directed through a first guide block 117 that is secured to an L-shaped mounting bracket 118 by a plurality of bolts 119. Mounting bracket 118 is in turn coupled to a guide arm 120 with a plurality of bolts 121. Bracket 118 includes elongated slots 122. Likewise, guide arm 120 includes elongated slots 123 which crossover and are alignable with the slots 122 to receive bolts 121. Use of bolts 121 and associated nuts allow first guide block 117 to be selectively moved to various positions depending upon the size of facer 33. First guide block 117 is positioned above and at the left side of front facer 33 and effectively twists rail 91A about 75 degrees from its original orientation when leaving rail former 95A. To that end, first guide block 117 includes a channel 124 shaped and sized to receive first rail 91A therethrough. As is evident from FIG. 17B, channel 124 is rotationally oriented about 75 degrees counterclockwise relative to the orientation of rail 91A as it exits rail former 94. Thus, rail 91A is somewhat twisted as it is continuously drawn through first guide block 117.

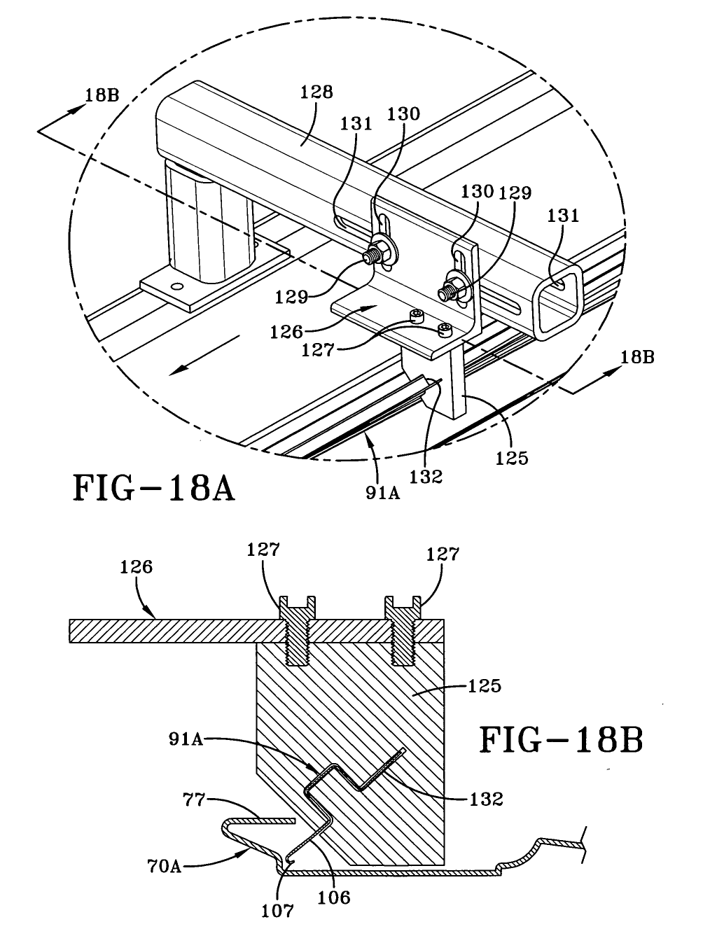

Referring now to FIGS. 18A and 18B, left rail 91A is next guided through a second guide block 125, downstream from first guide block 117. Second guide block 125 is secured to an L-shaped mounting bracket 126 by a plurality of bolts 127 and is positioned above and at the left side of front facer 33. Mounting bracket 126 is in turn coupled to a guide arm 128 with a plurality of bolts 129. Bracket 126 includes elongated slots 130. Likewise, guide arm 128 includes elongated slots 131 which crossover and are alignable with the slots 130 to receive bolts 129. Because bolts 129 are received through elongated slots 130 on bracket 126 and elongated slots 131 on guide arm 128, second guide block 125 may be selectively moved and then secured with nuts to various positions depending upon the size of the facer 33. Second guide block 125 includes a channel 132 shaped to receive first rail 91A therethrough. Channel 132 is rotationally oriented about 40 degrees counterclockwise relative to the orientation of rail 91A as it exits rail former 95A. At this point in the process, as is evident from FIG. 18B, first leg 106 and hook portion 107 are positioned below and laterally inside of third leg 77 of left profile 70A.

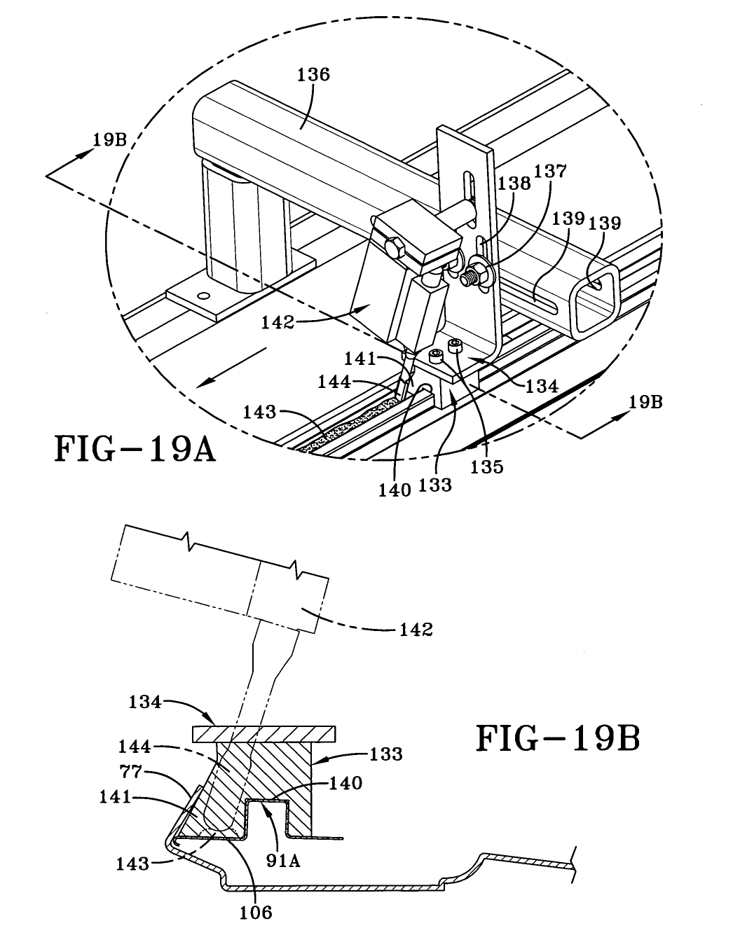

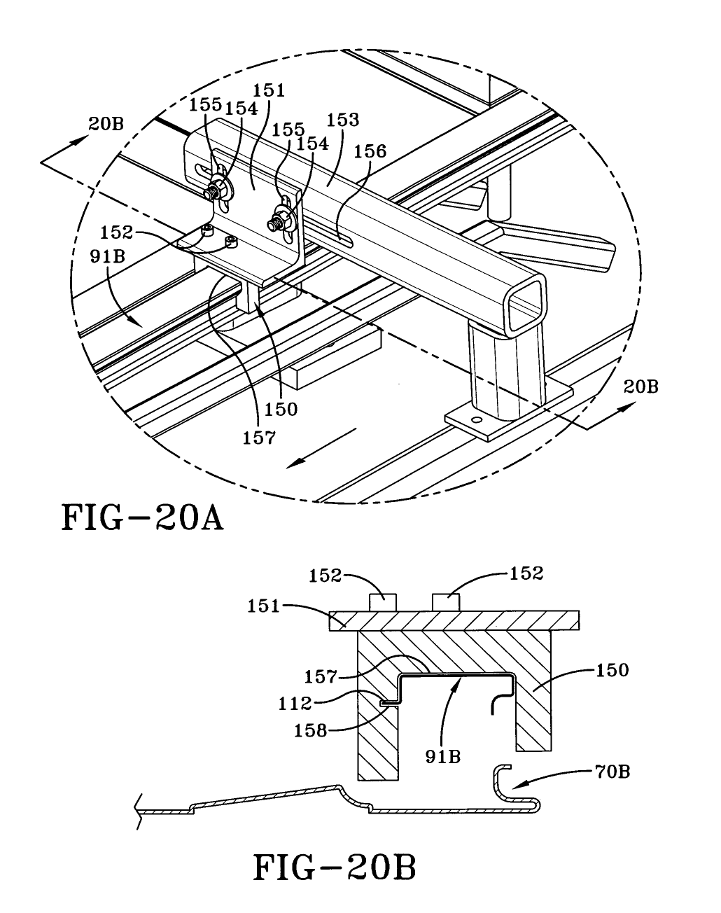

Referring now to FIGS. 19A and 19B, left rail 91A is next guided through a third guide block 133, downstream from second guide block 125. Third guide block 133 is secured to an L-shaped mounting bracket 134 with a plurality of bolts 135. Mounting bracket 134 is in turn coupled to a guide arm 136 with a plurality of bolts 137. Bracket 134 includes at least one elongated slot 138. Guide arm 136 also has elongated slots 139 which crossover and are alignable with slots 138 to receive bolts 137. Because bolts 137 are received in elongated slots 138 on bracket 134 and elongated slots 139 on guide arm 136 and then secured, third guide block 133 may be selectively moved to various positions and fastened depending on the size of facer 33. Third guide block 133 includes an open notch 140 extending along the bottom surface thereof that is shaped and sized to receive the U-shaped leg 105 of left rail 91A. Notch 140 is oriented to bring left rail 91A back to the original rotational orientation that it had as it left rail former 95A. As is evident from sequential FIGS. 17B, 18B, and 19B, left rail 91A is first twisted counterclockwise and then, as it is drawn downstream, it rotates clockwise to orient first leg 106 underneath and adjacent to third leg 77 of left profile 70A.

Third guide block 133 also includes an anvil portion 141 that is received beneath third leg 77 deflecting it upwardly. Thus, in this manner, left rail 91A is continuously tucked or inserted under third leg 77. An adhesive applicator 142 is connected to the bracket 134 and/or guide arm 136, and positioned proximate to the downstream side of anvil 141. The applicator 142 includes a tip 144 which dispenses a continuous bead 143 of adhesive onto a top surface of first leg 106 of rail 91A. Front facer 33 is generally resilient and third leg 77 naturally returns to a substantially horizontal orientation after passing by anvil portion 141 and tip 144. Adhesive bead 143 thereafter secures left rail 91A and left profile 70A to one another.

Referring now to FIGS. 20A and 20B, right rail 91B exits rail former 95B and is first directed through a fourth guide block 150 that is positioned above and at the right side of front facer 33 passing through the forming apparatus 94. Fourth guide block 150 is secured to an L-shaped mounting bracket 151 with a plurality of bolts 152. Mounting bracket 151 is in turn secured to a guide arm 153 with a plurality of bolts 154. Bracket 151 provides elongated slots 155 and guide arm 153 provides elongated slots 156. The elongated slots 155 and 156 are alignable with one another to receive bolts 154, which receive appropriate fasteners so that on guide arm 153, fourth guide block 150 may be selectively moved to various positions and secured depending upon the size of the facer 33. Unlike left rail 91A, right rail 91B does not undergo any twisting during the joining process because it is joined to the top surface of third leg 80 and inwardly facing surface of second leg 79. Thus, right rail 91B only needs to be effectively lowered onto right profile 70B, and aligned properly during adhesive application. To that end, fourth guide 150 includes a channel 157 on the bottom surface thereof that is shaped to receive U-shaped leg 110. Fourth guide block 150 may further include a laterally extending slot 158 adjoining channel 157 and shaped and sized to receive third leg 108 therethrough. In this manner, fourth guide 150 properly aligns right rail 91B as it travels therethrough.

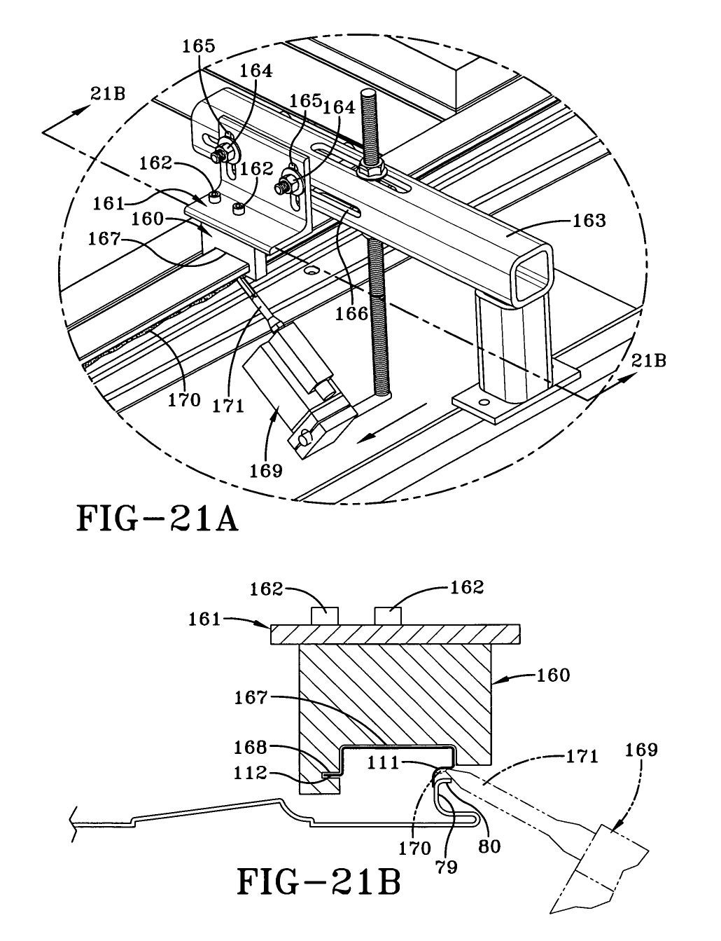

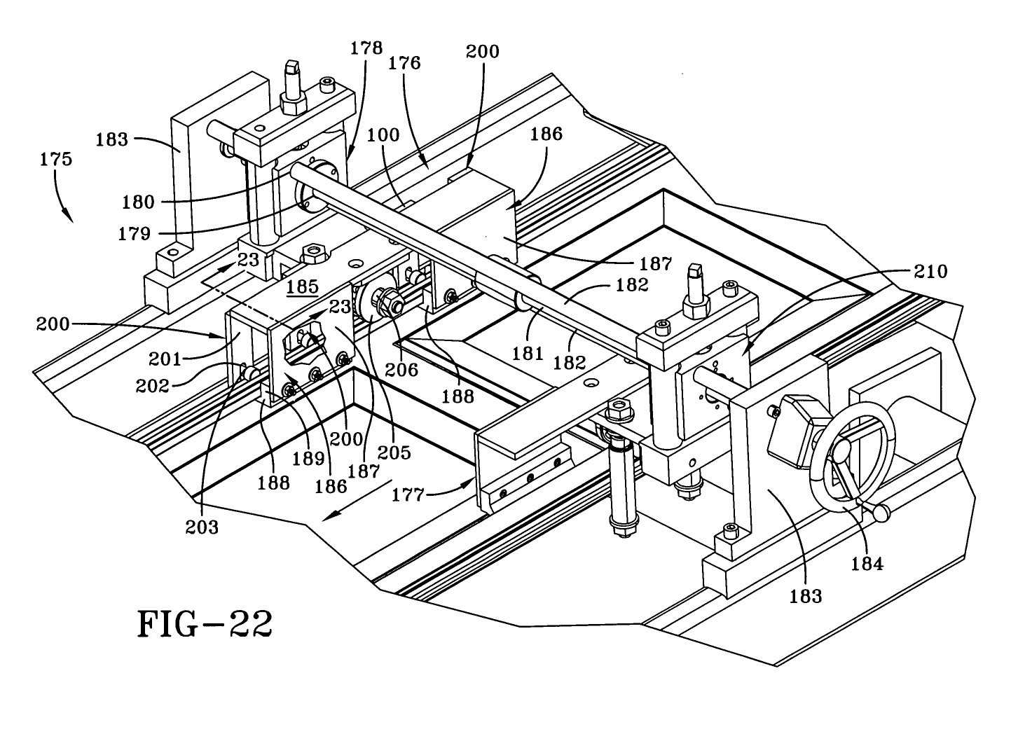

Referring now to FIGS. 21A and 21B, right rail 91B is next guided through a fifth guide block 160, downstream from fourth guide block 150. Fifth guide block 160 is positioned above and at the right side of front facer 33. Fifth guide block 160 is secured to an L-shaped mounting bracket 161 with a plurality of bolts 162. Mounting bracket 161 is in turn secured to a guide arm 163 with a plurality of bolts 164. Bracket 161 provides elongated slots 165 and guide arm 163 provides elongated slots 166. The elongated slots 165 and 166 are alignable with one another to receive bolts 164, which receive appropriate fasteners so that fifth guide block 160 may be selectively moved and secured to various positions depending upon the size of the facer 33. Fifth guide block 160 includes a channel 167 in the bottom surface thereof that is sized and shaped to receive U-shaped leg 110. Fifth guide block 160 may further include a laterally extending slot 168 adjoining channel 167 that is sized and shaped to receive third leg 108 therethrough. In this manner, fifth guide block 160 properly aligns right rail 91B as it travels therethrough. Further, an adhesive applicator 169 is secured to the guide arm 163 and positioned proximate to the downstream side of fifth guide block 160. Applicator 169 includes a tip 171 which dispenses a continuous bead 170 of adhesive onto the outwardly facing surface of J-shaped leg 111. Soon thereafter, as will become evident, J-shaped leg 111 contacts second leg 79 and third leg 80 with adhesive bead 170 therebetween to couple the two components together.

As shown in FIG. 13, after traveling through and between the plurality of guide blocks, front facer 33 and rails 91 are thereafter directed through a plurality of pressing assemblies 175. Though the figures show three pressing assemblies, more or less may be used. Pressing assembly 175 completes the merger of rails 91 and front facer 33 by both guiding the components and applying a compressive force thereto. Each pressing assembly 175 includes a left side sub-assembly 176 and a right side sub-assembly 177. As will become evident, left side sub-assembly 176 effectively guides and presses together left rail 91A and left profile 70A as they travel therethrough. Likewise, right-side sub-assembly 177 guides and presses together right rail 91B and right profile 70B.

Referring now to FIGS. 22 and 23, left side sub-assembly 176 includes a mounting block 178 having a central aperture 179 and a pair of apertures 180 at opposed corners. Central aperture 179 receives an adjusting rod 181 therethrough and apertures 180 each slidably receive stabilizing rods 182 therethrough. Adjusting rod 181 may include threads on the outer surface thereof. Likewise, central aperture 179 may include mating threads on the internal surface thereof. As will be discussed in detail below and as seen in FIG. 22 and 24, a similar pair of end plates 183 may be provided on opposed sides of pressing assembly 175 and may fixedly receive and couple to stabilizing rods 182. Thus, mounting block 178 may slide freely along stabilizing rods 182. End plates 183 may further include bores that rotatably receive adjusting rod 181 therethrough. A wheel 184 may be secured to one end of adjusting rod 181. Thus, rotation of wheel 184 causes rotation of adjusting rod 181, which causes corresponding inward or outward movement of mounting block 178. In this manner, left side sub-assembly 176 may be positioned to receive facers of varying size.

A generally T-shaped upper arm 185 couples to mounting block 178. Indeed, arm 185 extends substantially perpendicularly and laterally from the mounting block 178. A pair of lower supports 186 are secured to opposed ends of T-shaped upper arm 185 on the inner facing surface thereof. Lower supports 186 each include a plate 187 that extends downwardly from an edge of T-shaped upper arm 185, and a sled 188 that extends substantially perpendicularly from a bottom edge of plate 187. Referring to FIG. 23, it can be seen that sled 188 includes an upwardly extending flange 189 through which a pair of holes 190 are provided. Corresponding holes 191 are provided in plate 187 to receive bolts 192 therethrough to allow connection of the sled to support 186. Sled 188 includes a wedge portion 193 shaped to fit within the area formed between second and third leg 76 and 78 of left profile 70A. Further, sled 188 includes a top surface 194 that is adapted to slidingly contact first leg 106 and third leg 108 of left rail 90A. A projection 195 extends upwardly from top surface 194 and is adapted to be received within a portion of the channel formed by U-shaped leg 105. Sleds 188 are therefore adapted to provide support and guidance for end profile 70A and rail 91A. As will hereinafter become apparent, sled 188 provides a surface against which left rail 91A and left profile 70A may be pressed.

Two pairs of roller assemblies 200 are secured to T-shaped arm 185 on the outwardly facing surface thereof. Each pair of roller assemblies 200 are associated with one sled 188 and include a plate 201 extending downwardly from an opposite edge of T-shaped arm 185. Plate 201 includes a slot 202 through which a shaft 203 is rotatably received. A roller 204 is secured to the end of shaft 203 and is positioned to engage and press against the top surface of third leg 77 of edge profile 70A. In this manner, rail 90A and left profile 70A are positioned and pressed against one another. As shown in FIG. 23, first leg 106 of rail 91A and third leg 77 of profile 70A are pressed between rollers 204 and top surface 194 of sled 188. Because adhesive 143 is situated between third leg 77 and first leg 106, rail 91A and profile 70A are joined as facer 33 and rail 91A are simultaneously and continuously fed through pressing assembly 175. In order to promote a low friction interface, rollers 204 are free to rotate and sled 188 may be composed of a high density, low coefficient of friction, plastic material.

Left side sub-assembly 176 may further include a central roller 205 that is rotatably carried on a shaft 206 which may be cantilevered from one of the plates 201 or mounting block 178. Central roller 205 is positioned between sleds 188 and includes a circumferential channel 207 sized to receive a portion of U-shaped leg 105 therein. Thus, as rail 91A travels through pressing assembly 175, central roller 205 rotates to provide a low friction guide. Further, central roller 205 may provide some downward force on rail 91A to promote coupling with front facer 33. Central roller 205 may optionally include one or more magnets 208 positioned circumferentially within channel 207. Magnets 208 draw rails 91A into channel 207 so that rails 91A are properly seated and positioned accurately.

Thus, left side sub-assembly 176 applies a compressive force between rail 91A and profile 70A to allow adhesive 143 to couple the two components. Further, left-side sub-assembly 176 guides and holds the components in proper alignment during the adhering process.

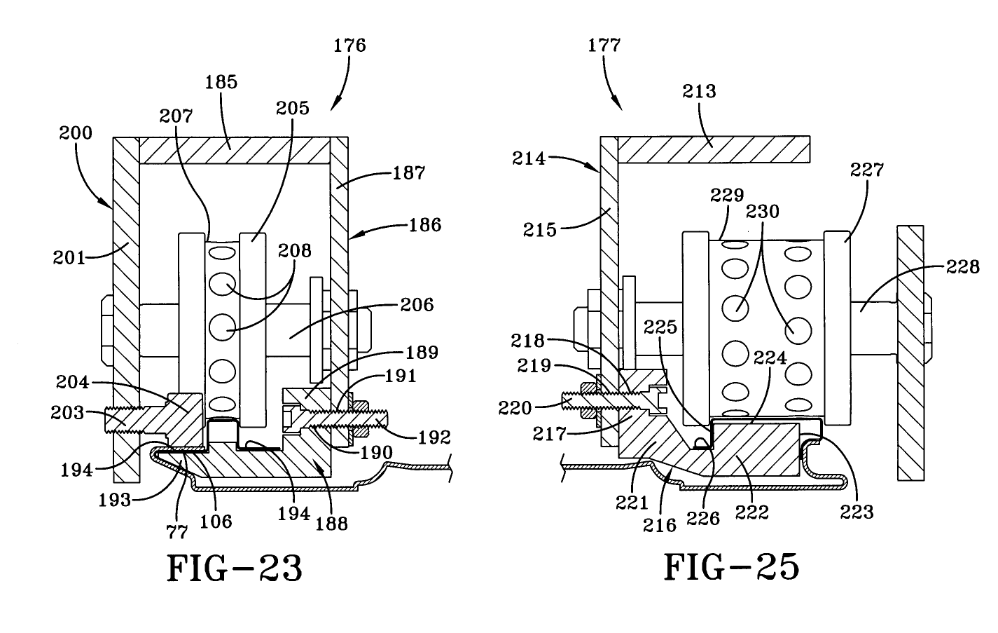

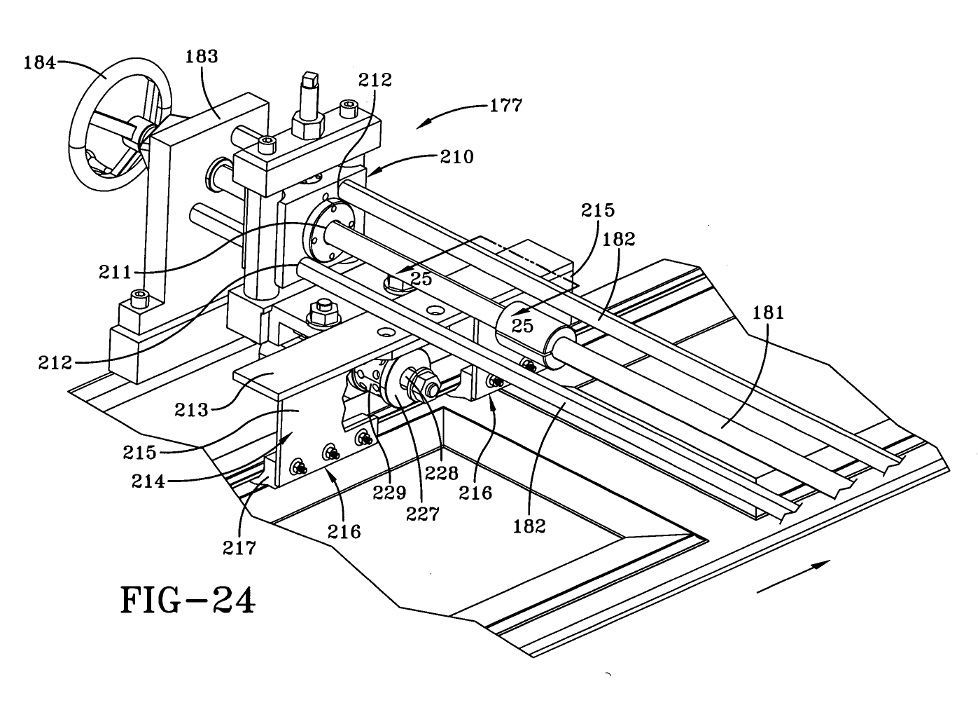

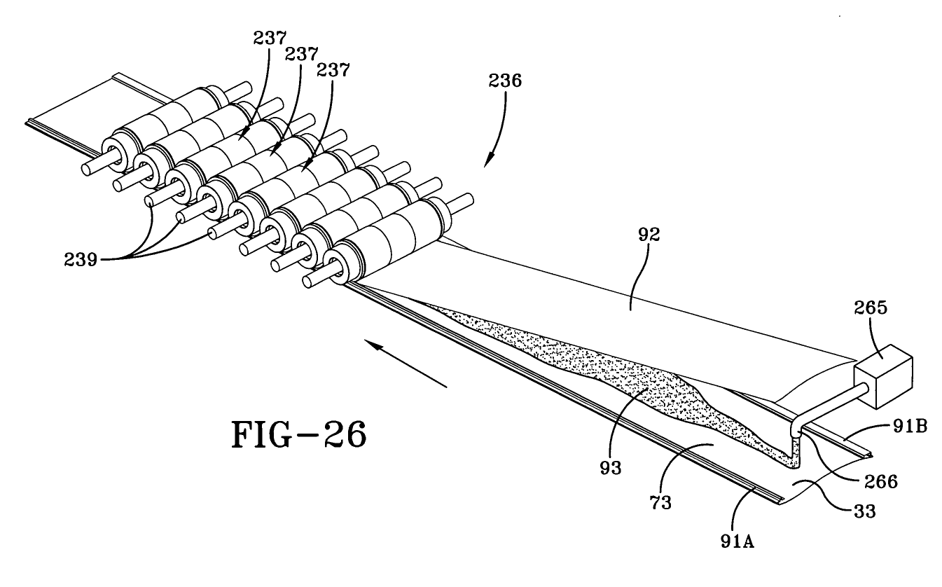

Referring now to FIGS. 24 and 25, right side sub-assembly 177 is adapted to guide and hold together right rail 91B and right profile 70B as they travel therethrough. Thus, right side sub-assembly 177 includes a mounting block 210 having a central aperture 211 and a pair of apertures 212 at opposed corners. Central aperture 211 receives adjusting rod 181 therethrough and apertures 212 each slidably receive stabilizing rods 182 therethrough. Central aperture 211 may include threads on the internal surface thereof that mate with threads of adjusting rod 181. It should be appreciated that the threads of adjusting rod 181 that contacts central aperture 211 may be oriented opposite of the threads at the area that contact central aperture 179 of mounting block 178. Thus, when adjusting rod 181 is rotated, mounting blocks 178 and 210 will jointly move inwardly our outwardly. In this manner, the right side sub-assembly and the left side sub-assembly may be adjusted to receive facers of varying size.

Right-side sub-assembly includes a T-shaped upper arm 213 coupled to mounting block 210. A pair of lower supports 214 are secured on opposed ends of T-shaped upper arm 213 on the inner facing surface thereof. Lower supports 214 each include a plate 215 that extends downwardly from T-shaped upper arm 213, and a sled 216 that extends substantially perpendicularly from the bottom end of plate 215. As best seen in FIG. 25, sled 216 includes an upwardly extending flange 217 through which a pair of holes 218 are provided. Corresponding holes 219 are provided in plate 215 to receive bolts 220 therethrough to allow attachment of sled 216 to plate 215. Sled 216 includes a leg 221 extending outwardly from flange 217 that terminates at a guide portion 222 that is received at least partially within the channel formed by U-shaped leg 110 of rail 91B. Guide portion 222 includes an outwardly facing surface 223 that terminates at a first upwardly facing surface 224 which in turn terminates at an inwardly facing surface 225, which in turn terminates at a second upwardly facing surface 226. Second upwardly facing surface 226 may contact and support third leg 112 of rail 91B. Inwardly facing surface 225 may contact and support a portion of U-shaped leg 110 and outwardly facing surface 223 may contact and support a portion of J-shaped leg 111. As will become apparent, sleds 216 are adapted to provide support and guidance for end profile 70B and rail 91B.

Right-side sub-assembly 177 as best seen in FIG. 24, may further include a central roller 227 that is rotatably carried on a shaft 228 which may be cantilevered from mounting block 210. Central roller 227 is positioned between sleds 216 and includes a circumferential channel 229 sized to receive a portion of U-shaped leg 110 therein. Thus, as rail 91B travels through right side sub-assembly 177, central roller 227 rotates to provide a low friction guide. Further, central roller 227 may provide some downward force on rail 91B to promote coupling with front facer 33. Central roller 227 may optionally include one or more magnets 230 positioned circumferentially within channel 229. Magnets 230 draw rails 91B into channel 229 so that rails 91B are properly seated and positioned accurately. In this manner, central roller 227 and guide portion 222 hold rail 91B and profile 70B in an abutting relationship to allow adhesive 170 to join the two components. Specifically, J-shaped leg 111 is held against second and third leg 79 and 80. Thus, facer 33 and rail 91B are joined as they are simultaneously and continuously fed through pressing assembly 175. As above, in order to promote a low friction interface, sled 216 may be comprised of a high density, low friction coefficient plastic material.

Referring now to FIGS. 14 and 26, a rear facer 92 may be continuously provided from a rear facer stock roll 235 which may be positioned above and forward of merging apparatus 115. Rear facer 92 may be of a plastic composition and may for example be polyvinylchloride, although any plastic may be used. In other embodiments rear facer 92 may be craft paper or the like. Rear facer 92 is continuously fed from rear facer stock roll 235 into a laminator 236 to be joined with other door panel components as will be hereinafter described.

Adhesion to the various panel components may be improved by treating front facer 33 and/or rear facer 92 with a corona process to raise the surface tension thereon. With respect to rear facer 92, the treatment may be performed prior to bringing stock roll 235 to the assembly area, or it may be performed in a continuous manner during assembly. The corona process requires the application of a high voltage, high frequency discharge in atmospheric air which acts to raise the surface energy of the targeted area. This higher surface energy is created when the surface molecules add and delete electrons. Typical dyne levels achieved are in the range of 40-50 dyne and last for approximately 4 hours. Due to this being a continuous process, the facer's surface energy remains high throughout the laminating process, promoting bonding and adhesion to the foam material.

The joining of the various components can be seen with reference to FIG. 26. The assembled front facer 33 and rails 91 exit pressing assembly 175 and are continuously drawn into laminator 236. Prior to entry into laminator 236, a foam unit 265 provides foam material 93 through a nozzle 266 onto the upwardly facing surface 73 of front facer 33. Foam material 93 may be any substance that expands and therafter cures into a solid structure. Exemplary foam materials may include polyurethane/isocyanurate mixtures. In one or more embodiments the mix ration may be about 50/50. In other embodiments, the foam material may be a pentane blown styrene foam. In one ore more embodiments the foam density may be about 2.0 to about 2.8 pcf. In the present embodiment a single nozzle 266 is shown, though it should be appreciated that a plurality of nozzles may be employed. Just prior to entry into laminator 236 rear facer 92 is brought into contact with rails 91 to create an enclosed volume V (see FIG. 30). In other words, rails 91, front facer 33 and rear facer 92 form a closed exterior skin or perimeter, defining the volume V therein. Thereafter, the assembled panel is drawn through laminator 236. Inside laminator 236, foam 93 continues to expand and substantially fill volume V defined by front facer 33, rear facer 92 and rails 91.

Laminator 236 may include a plurality of spaced rollers 237. One or more of the rollers 237 may be rotated in unison by a single or a plurality of roller motors (not shown). In the case of a single motor, the plurality of rollers may be interrelated by belts or chains so that rotation occurs in unison. Further as best seen in FIGS. #27 A-C, a belt 238 may be provided below rollers 237 so that the assembled door panel is drawn continuously therebetween. Though the present embodiment discloses a roller and belt type laminator, other suitable types of laminators may be employed. For example, a roller chain conveyor using pressure platens may be used. Such laminators are disclosed in U.S. Pat. No. 5,836,499 which is hereby incorporated by reference.

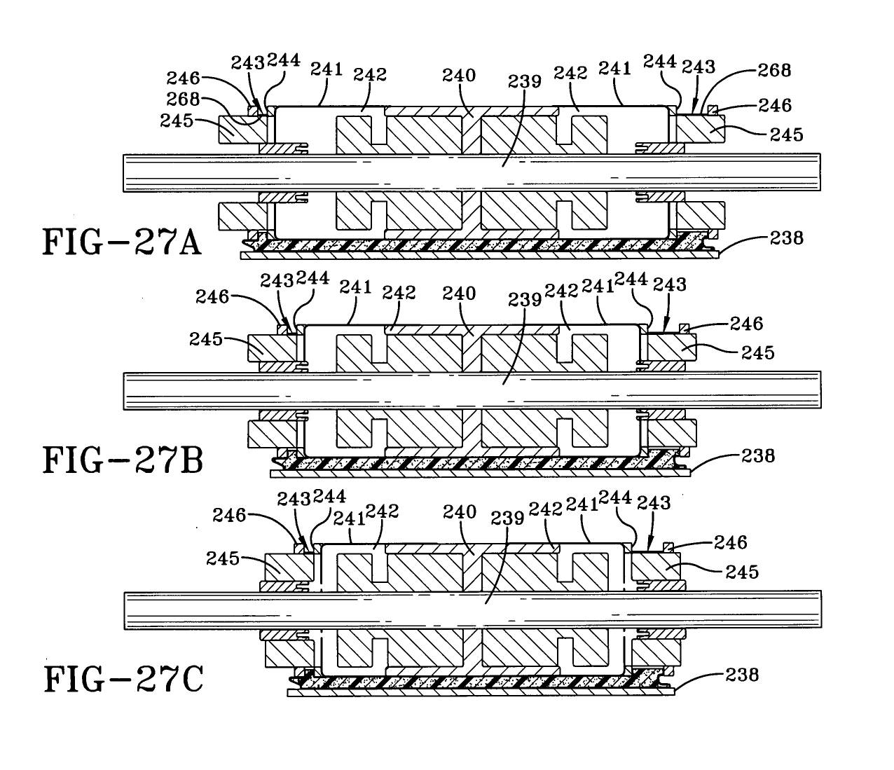

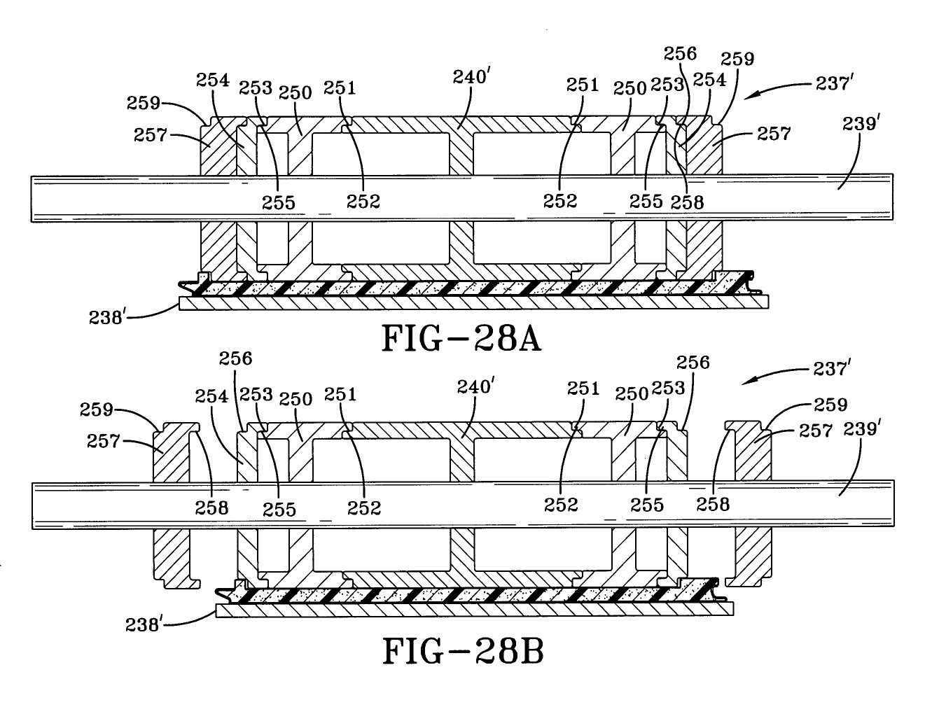

Referring now to FIGS. 26 and 27A-27C, laminating rollers 237 may include an axle 239 that is rotatable and carries a central core 240 thereon. Central core 240 is substantially cylindrical, a portion of which may be adapted to contact rear facer 92 as it is drawn through laminator 236. In this manner, front and rear facers 33 and 92 may be positioned and held during lamination. Rollers 237 further include a pair of opposed adjustable end caps 241 that may be moved axially inward or outward depending upon the size of door panel being manufactured. To that end, each end cap 241 includes a collar 242 that is cylindrical and is sized to be slidably received over central core 240. Thus, the overall axial length of the roller 237 may be adjusted, as shown sequentially in FIGS. 27A-27C, by moving end caps 241 inwardly or outwardly relative to central core 240. End caps 241 each include a circumferential guide 243. Guides 243 are adapted to releasably receive and position rails 91 as they travel through laminator 236. This prevents unwanted shifting and movement during lamination. The present embodiment includes a guide in the form of a circumferential groove formed by inner wall 244, cylindrical extension 245 and circumferential flange 246. In other embodiments, circumferential flange 246 may not be included and thus, guides 243 are in the form of a stepped area instead of a channel. Thus, guides 243 respectively receive a portion of U-shaped leg 105 of left rail 91A and a portion of U-shaped leg 110 of right rail 91B as they travel through laminator 236.

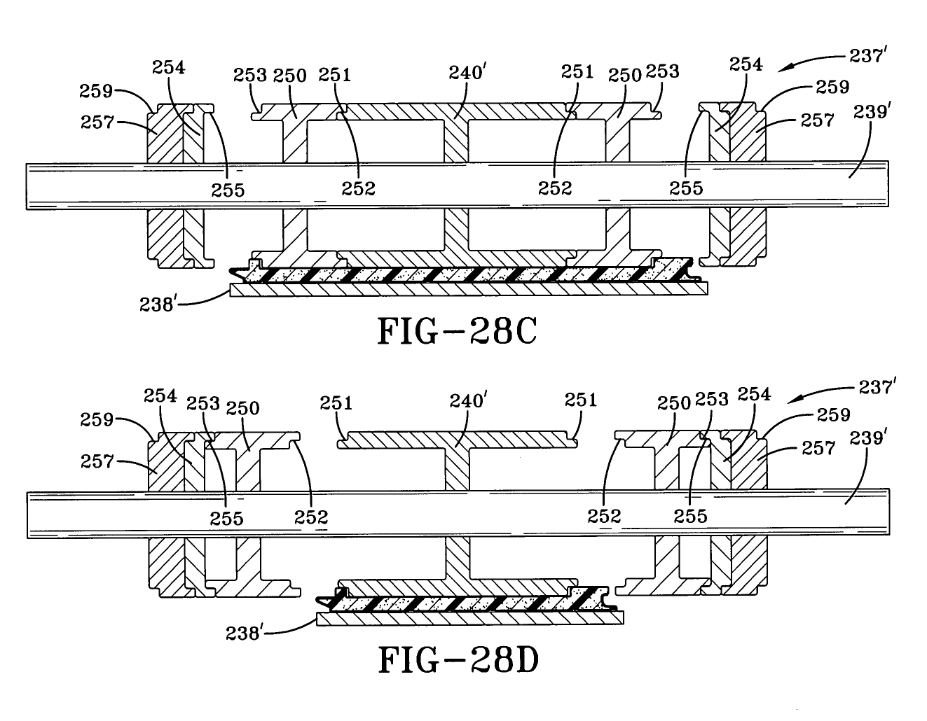

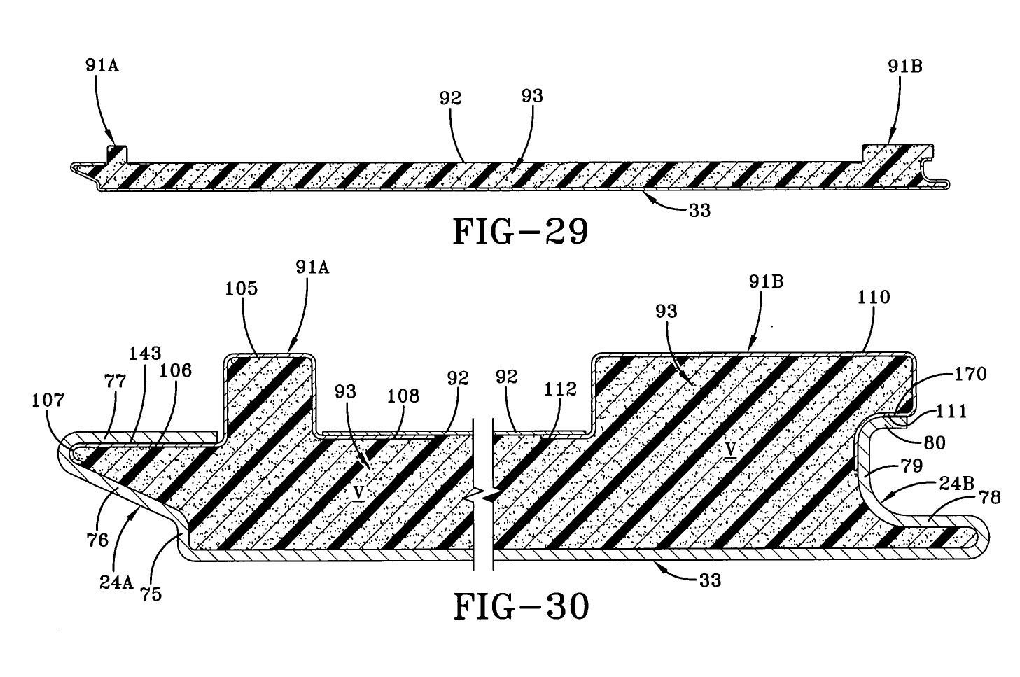

An alternate roller embodiment is shown in FIGS. 28A-28D. Roller 237′ may include an axle 239′ that is rotatable and carries a central core 240′ thereon. Central core 240′ includes a substantially cylindrical portion which may be adapted to contact rear facer 92 as it is drawn through laminator 236. A plurality of end caps may be provided that optionally may be joined with core 240′ to allow for varying facer sizes. Thus, a first end cap 250 is provided on opposed sides of core 240′. First end cap 250 includes an outer circumference that may be of about the same diameter as the outer circumferences of core 240′. Core 240′ may include a notched portion 251 that, as will become evident, is adapted to guide rail 91 or, in the alternative, to mate with an inner notched portion 252 of first cap 250. First cap 250 further includes an outer notched portion 253 that, as will become evident, is adapted to guide rail 91 or, in the alternative, to mate with a second end cap 254. Second end cap 254 may include an outer circumference that may be of about the same diameter as the outer circumference of core 240′. Further, second end cap 254 may include an inner flange 255 that is shaped to mate with outer notched portion 253 of first cap 250. Second end cap 254 further includes an outer notched portion 256 that is adapted to guide rail 91, or in the alternative, to mate with a third end cap 257. Third end cap may include an outer circumference that may be of about the same diameter as the outer circumference of core 240′. Third end cap 257 may include an inner flange 258 that is shaped to mate with outer notched portion 256 of second end cap 254. Finally, third end cap 257 includes an outer notched portion 259 that is adapted to guide rail 91.

As is evident from FIGS. 28A-28D, end caps 250, 254 and 257 may be stacked to allow for various facer sizes. Referring to FIG. 28A, first end cap 250, second end cap 254 and third end caps 257 are positioned in an abutting relationship wherein outer notched portion 259 may guide rail 91 during lamination and wherein the outer circumferences of core 240′, first end cap 250, second end cap 254 and third end cap 257 provide a surface against which rear facer 92 may bear. Referring to FIG. 28B, third end cap 257 may be displaced from second end cap 254 and either completely removed or simply moved outwardly. In this embodiment, outer notched portion 256 guides rail 91 during lamination. Referring to FIG. 28C, second end cap 254 and third end cap 257 are displaced from first end cap 250 in the same manner as above. In this embodiment, outer notched portion 253 guides rail 91 during lamination. Finally, referring to FIG. 28D, first end cap 250, second end cap 254 and third end cap 257 are displaced from core 240′. In this embodiment, notched portion 251 guides rail 91 during lamination. In this manner, roller 237′ may quickly be modified to produce door panels with different sized facers.

With reference now to FIGS. 29 and 30, the cross-sectional profile of the joined components can be seen. As is evident, first leg 106 of left rail 91A is positioned in a parallel abutting relationship beneath third leg 77 of left profile 70A. As discussed above, adhesive 143 promotes adhesion to between third leg 77 and first leg 106. Further, hook portion 107 rests in the intersection of second and third legs 76 and 77. Rear facer 92 rests on top of and in abutting relation to flat leg 108 at rail 91A. An adhesive may be applied to the top surface of leg 108 by an adhesive applicator 260 (see FIG. 14) positioned upstream of laminator 236. In this manner, rear facer 92 is coupled to left rail 91A L-shaped leg 111 of right rail 91B is positioned in abutting relation to second and third leg 79 and 80 of right profile 70B. As discussed above, adhesive 170 is provided on the outward facing surface of first leg L-shaped leg 111 to promote adhesion to right profile 70B. Rear facer 92 rests on top of, and in abutting relation to third leg 112. As before, an adhesive may be applied to a top surface of right rails third leg 112 by adhesive applicator 260. In this manner, rear facer 92 is coupled to right rail 91B.

As evidenced in FIGS. 29 and 30, foam 93 expands within volume V to fill substantially the entire area between front facer 33 and rear facer 92 and between rails 91A and 91B. Once cured, foam 93 provides both structural integrity and holds the various components together. To promote complete curing of foam 93, laminator rollers 237 may be positioned within an oven 267 to elevate the temperature of the components. Thus, in this manner, as the assembled components move through laminator 236, foam 93 expands and hardens. While foam 93 is curing, the various elements must be held in a proper position. To that end, U-shaped legs 105 and 110 of rails 91A and 91B are releasably received within guides 243 of rollers 237. In this way, the guides 243 of the plurality of rollers 237 maintain rails 91 in proper alignment during lamination. In one or more embodiments, magnets 268 may be provided within guides 243 to more securely hold rails 91 therein. In the alternative embodiment of FIGS. 28A-28D, outer notched portions 251, 256 or 259 receive a portion of U-shaped legs 105 and 110 to guide rails 91 and prevent shifting or misalignment.

It should further be appreciated that maintaining tension on the various components prior to and during lamination may improve quality and uniformity. Specifically, too little tension may result in component shifting, misalignment, wrinkles or poor adhesion of the facers and/or rails to the foam. If tension is too great, the facers may display stress marks and foam adhesion may not be optimal. Thus tension can be placed on the front facer 33 by speed differentials between the speed of the motorized puller assembly 72 and the speed of rollers 237 in the laminator 236. The same is true for rails 91 as tension can be placed on the rails 91 by speed differentials between rail formers 95 and the speed of rollers 237 in laminating oven 267. Further, tension may be placed on rear facer 92 by speed differentials between the feeder roll 235 and the roller speed of laminator rollers 237 such that the rear facer 92 is held under adequate tension.

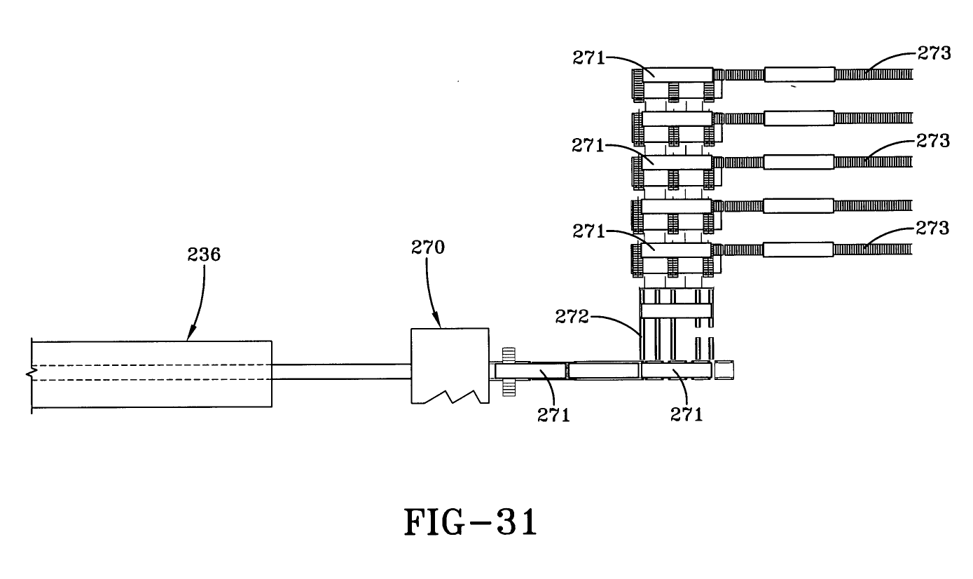

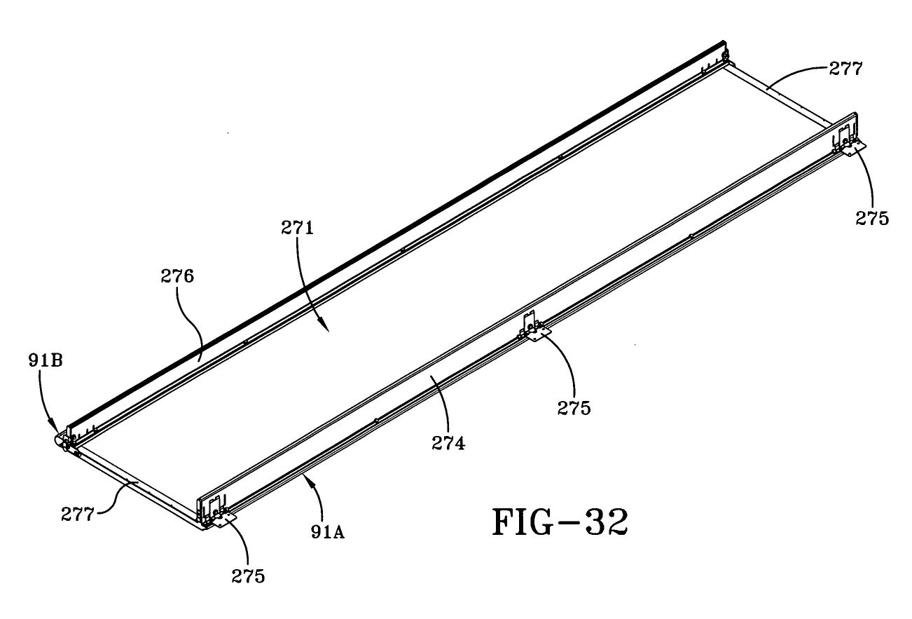

Referring now to FIG. 31, upon exiting the laminator 236, foam 93 is substantially cured, and the now rigid continuous length of panel may be cut to the appropriate length at a saw house 270. Individual cut panels 271 are thereafter directed along a transverse conveyor 272 to one of a plurality of finishing lines 273 where additional components are mounted thereon.

Referring now to FIG. 32, a cut, cured panel 271 is shown with various additional components mounted thereon. For example, in the present embodiment, a lateral strut 274 may be mounted over the U-shaped leg 105 of left rail 91A. Lateral strut 274 adds structural integrity to door panel 271 and further provides a suitable mounting area for one or more hinges 275 and outwardly extending rollers. An additional lateral strut 276 may be provided over U-shaped leg 110 of right rail. This additional strut may be used, for example at the top or bottom panel of a complete door assembly. Spaced hinges 275 are provided along the longitudinal edge of panel 271 as a means to secure adjoining panels together and allow pivoting relative motion therebetween. Finally, end caps 277 may be secured to the ends of panel 270 with adhesives, mechanical fasteners or the like, to promote the aesthetics of the door and to protect the exposed foam 93. Other components may be attached to panel 271. Exemplary door panel components and the arrangement thereof are shown in co-pending U.S. patent application Ser., No. 11/211,296 which is hereby incorporated by reference.

In the above described manner, a dual plastic facer panel may be continuously formed. The above method advantageously allows door panels to be produced in a continuous fashion instead of through the batch process of the prior art. Further, the above method allows for dissimilar materials (i.e. metal of the rails and plastic of the facers) to be integrated in a continuous process. Indeed, the facers may be a combination of paper (facer 92) and plastic (facer 33) and the disclosed process allows for relatively quick changeovers of material and adjustments to the width of the panels constructed by the process. Still further, the resulting plastic door panels are resistant to denting and environmental deterioration, such as struts rusting and paint peeling, while allowing conventional attachment of door hardware such as hinges and the like. Still further, the above method minimizes the differential of thermal expansion and eliminates the need to provide backup materials internal to the panel for attaching components with conventional fasteners.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto and thereby. Accordingly, for an appreciation of the true scope and breadth of the invention, reference should be made to the following claims.

What is claimed is:

1. A method of forming a door panel comprising:
continuously providing a first facer having opposed longitudinal edge profiles;
continuously securing a metal rail to each said opposed longitudinal edge profile;
continuously bringing a second facer into contact with said rails; and
drawing said first facer, said second facer and said rails through a laminator including a plurality of rollers; wherein said rollers releasably position said rails as they are drawn through said laminator.

2. The method of claim 1 further comprising
applying a foaming material between said facers prior to entry into said laminator, said foam being expandable to fill substantially the entire volume defined between said first facer, said second facer and said rails.

3. The method of claim 1 further comprising applying a continuous tension on said rails and said first facer as they move through said laminator.

4. The method of claim 1 wherein said step of continuously securing further comprises the step of applying an adhesive between said metal rails and said longitudinal edge profiles.

5. The method of claim 1 further comprising continuously forming said rails to each include a cross-sectional shape, at least one of said cross-sectional shapes being adapted to receive a strut.

6. The method of claim 1 wherein said step of continuously providing said first facer further comprises the step of extruding a sheet of plastic material through a die.

7. The method of claim 6 wherein said step of continuously providing said first facer further includes the step of drawing said sheet through a vacuum former to transpose a repeating pattern onto said sheet.

8. The method of claim 6 wherein said step of continuously providing said first facer further includes the step of drawing opposed longitudinal edge portions of said sheet through a plurality of edge formers while said first facer is in a formable condition to sequentially form said longitudinal edge portions into said longitudinal edge profiles.

9. The method of claim 1 further comprising the step of allowing said first facer to accumulate prior to said step of continuously securing said metal rail to each said opposed longitudinal edge profile.

10. The method of claim 1 wherein said step of providing a first facer having opposed longitudinal edge profiles further comprises the step of selectively adjusting the width of said first facer.

11. The method of claim 10 wherein said step of selectively adjusting further comprises the step of extruding a sheet of plastic through a die and cutting one or both edges of said sheet with an adjustable blade.

12. The method of claim 1 wherein said step of drawing said first facer, said second facer and said rails through said laminator including a plurality of rails further comprises the step of selectively adjusting the width of said rollers.

13. A method of forming a door panel comprising:
providing a first non-metallic facer having opposed longitudinal edge profiles;
joining said first non-metallic facer with a pair of metallic rails and a second non-metallic facer, said rails being positioned proximate said longitudinal edge profiles;
providing a foaming material, said foam being expandable to fill substantially the entire volume defined between said first non-metallic facer, said second non-metallic facer and said rails;
drawing said first facer, said second facer, said foaming material and said rails through a laminator, including a plurality of rollers; wherein said rollers include guides that releasably position said rails as they are drawn through said laminator.

14. The method of claim 13 further comprising the step of drawing tension on said rails as they move through said laminator.

15. The method of claim 13 further comprising the step of drawing tension on said first facer and said second facer as they move through said laminator.

16. The method of claim 13 wherein said step of joining said first non-metallic facer with a pair of metallic rails and a second non-metallic facer further comprising applying an adhesive between said rails and said longitudinal end profiles.

17. The method of claim 13 further comprising the step of continuously forming said rails to each include a cross-sectional shape, at least one of said cross-sectional shapes being adapted to receive a strut.

18. The method of claim 13 wherein said step of providing a first non-metallic facer having opposed longitudinal edge profiles further comprising selectively adjusting the width of said first non-metallic facer.

19. The method of claim 18 wherein said step of selectively adjusting the width of said first non-metallic facer further comprising extruding a sheet of plastic through a die and cutting one or both edges of said sheet with an adjustable blade.

20. The method of claim 13 wherein said step of drawing said first non-metallic facer, said rails and said second non-metallic facer and through a laminator including a plurality of rails further comprises selectively adjusting the lateral distance between said guides.

21. A method of forming a door panel comprising:
providing a plurality of spaced rollers above a moving surface;
drawing a first plastic facer between said rollers and said moving surface, said first facer being in the form of a continuous sheet and having an upwardly facing surface;
drawing a second plastic facer between said rollers and said moving surface, said second facer being in the form of a continuous sheet and at least a portion of said second facer being positioned above said first facer;
positioning a pair of rails on opposed sides of said first facer and drawing said rails between said rollers and said moving surface;
depositing a foam material on said upwardly facing surface prior to said step of drawing said first facer between said rollers and said moving surface, wherein said foam expands and hardens to adhere together said first facer, said second facer and said rails into a continuous length of the door panel.

22. The method of claim 21 wherein said step of positioning said pair of rails on opposed sides of said first facer further comprises providing each said rail with an upwardly protruding generally U-shaped leg, and each said roller with a guide, said U-shaped leg being received at least partially in said guide while said rails are drawn beneath said rollers.

23. The method of claim 21 wherein said step of drawing said first facer beneath said rollers further includes simultaneously tensioning said first facer while said first facer is drawn under said rollers.

24. The method of claim 21 wherein said step of drawing said second facer beneath said rollers further includes simultaneously tensioning said second facer while said second facer is drawn under said rollers.

25. The method of claim 21 wherein said step of positioning a pair of rails on opposed sides of said first facer and drawing said rails beneath said rollers further includes simultaneously tensioning said rails while said rails are drawn under said rollers.

26. The method of claim 21 further comprising cutting said continuous length of panel assembly into individual panels.

27. The method of claim 26 further comprising coupling at least one support strut to said individual panels at one of said rails.

28. A method of forming a door panel comprising:
providing a first non-metallic facer having opposed longitudinal edge profiles;
joining said first non-metallic facer with a pair of metallic rails and a second non-metallic facer, said rails being positioned at said longitudinal edges of said first non-metallic facer;
providing a foaming material, said foam being expandable to fill substantially the entire space between said first non-metallic and said second non-metallic facer;
continuously drawing said first non-metallic facer, said second non-metallic facer, said foaming material and said metallic rails through a laminator including at least one guide, to position said rails while moving therethrough.
